(19) United States
(12) Patent Application Publication
(10) Pub. No.: US 2025/0258547 A1
(43) Pub. Date: Aug. 14, 2025

(54) ELECTRONIC DEVICE FOR ACQUIRING HAPTIC INFORMATION FROM MEDIA CONTENT, AND METHOD THEREOF

(71) Applicant: Samsung Electronics Co., Ltd., Suwon-si (KR)

(72) Inventors: Jaehwan LEE, Suwon-si (KR); Hyunchul WOO, Suwon-si (KR); Hyungjoo YIM, Suwon-si (KR)

(21) Appl. No.: 19/194,661

(22) Filed: Apr. 30, 2025

Related U.S. Application Data
(63) Continuation of application No. PCT/KR2023/015889, filed on Oct. 13, 2023.

(30) Foreign Application Priority Data
Nov. 10, 2022 (KR) 10-2022-0149992
Nov. 16, 2022 (KR) 10-2022-0153966

(51) Int. Cl. G06F 3/01; G06F 3/16; G06T 7/90

(52) U.S. Cl. CPC G06F 3/016; G06F 3/165; G06T 7/90; G06T 2207/10024

(57) ABSTRACT

An electronic device, in a state of outputting media content through a speaker and a display, may acquire haptic information for outputting haptic feedback synchronized with the media content. The electronic device may identify capability information for the haptic feedback supported by an external electronic device connected through a communication circuit. The electronic device may transmit, to the external electronic device through the communication circuit, the haptic information which has been adjusted according to the capability information indicating whether the external electronic device includes at least one among a heating element or a vibration actuator.

### CROSS-REFERENCE TO RELATED APPLICATIONS

This application is a continuation application of International Application No. PCT/KR2023/015889, filed on Oct. 13, 2023, in the Korean Intellectual Property Receiving Office, and claiming priority to Korean Patent Application No. 10-2022-0149992 filed Nov. 10, 2022, and Korean Patent Application No. 10-2022-0153966 filed on Nov. 16, 2022, the disclosures of which are all hereby incorporated by reference herein in their entireties.

### BACKGROUND

### Technical Field

Certain example embodiments may relate to an electronic device for obtaining haptic information from a media content, and/or a method thereof.

### Background Art

An electronic device may output a media content. In a state of outputting the media content, electronic devices for reinforcing a user experience are being developed.

### SUMMARY

According to an example embodiment, an electronic device may comprise a display, a speaker, communication circuitry, and a processor comprising processing circuitry. The processor(s) may, in a state of outputting a media content through the speaker and the display, obtain haptic information to output haptic feedback synchronized with the media content. The processor(s) may identify capability information with respect to haptic feedback provided by an external electronic device connected through the communication circuitry. The processor(s) may transmit, to the external electronic device through the communication circuitry, haptic information adjusted by the capability information indicating whether the external electronic device includes at least one of a heat-generating element or a haptic actuator.

An example method of an electronic device according to an embodiment may comprise, in a state of outputting a media content through a speaker and a display, obtaining haptic information to output haptic feedback synchronized with the media content. The method of the electronic device may comprise identifying capability information with respect to haptic feedback provided by an external electronic device connected through communication circuitry. The method of the electronic device may comprise transmitting, to the external electronic device through the communication circuitry, haptic information adjusted by the capability information indicating whether the external electronic device includes at least one of a heat-generating element or a haptic actuator.

In a computer-readable storage medium storing one or more programs according to an embodiment, the one or more programs, when executed by at least one processor (individually and/or collectively) of an electronic device, may cause the processor(s) of the electronic device to, in a state of outputting a media content through a speaker and a display, obtain haptic information to output haptic feedback synchronized with the media content. The one or more programs, when executed by the processor(s) of the electronic device, may cause the processor(s) of the electronic device to identify capability information with respect to haptic feedback provided by an external electronic device connected through communication circuitry. The one or more programs, when executed by the processor(s) of the electronic device, may cause the processor(s) of the electronic device to transmit, to the external electronic device through the communication circuitry, haptic information adjusted by the capability information indicating whether the external electronic device includes at least one of a heat-generating element or a haptic actuator.

### BRIEF DESCRIPTION OF THE DRAWINGS

FIG. 1A illustrates an example of a block diagram of an electronic device according to an example embodiment.

FIG. 1B illustrates an example of a block diagram of an electronic device according to

an example embodiment.

FIG. 2A illustrates an example of a media content outputted by an electronic device according to an example embodiment.

FIG. 2B illustrates an example of a media content outputted by an electronic device according to an example embodiment.

FIG. 3 illustrates an example of a media content outputted by an electronic device according to an example embodiment.

FIG. 4 illustrates an example of a frequency of an audio signal for obtaining haptic information, according to an example embodiment.

FIG. 5 illustrates an example of haptic information, according to an example embodiment.

FIG. 6 illustrates an example of a flowchart of an operation of an electronic device according to an example embodiment.

FIG. 7 illustrates an example of a flowchart of an operation of an electronic device according to an example embodiment.

### DETAILED DESCRIPTION

Hereinafter, various embodiments of the present document will be described with reference to the accompanying drawings.

The various embodiments of the present document and terms used herein are not intended to limit the technology described in the present document to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

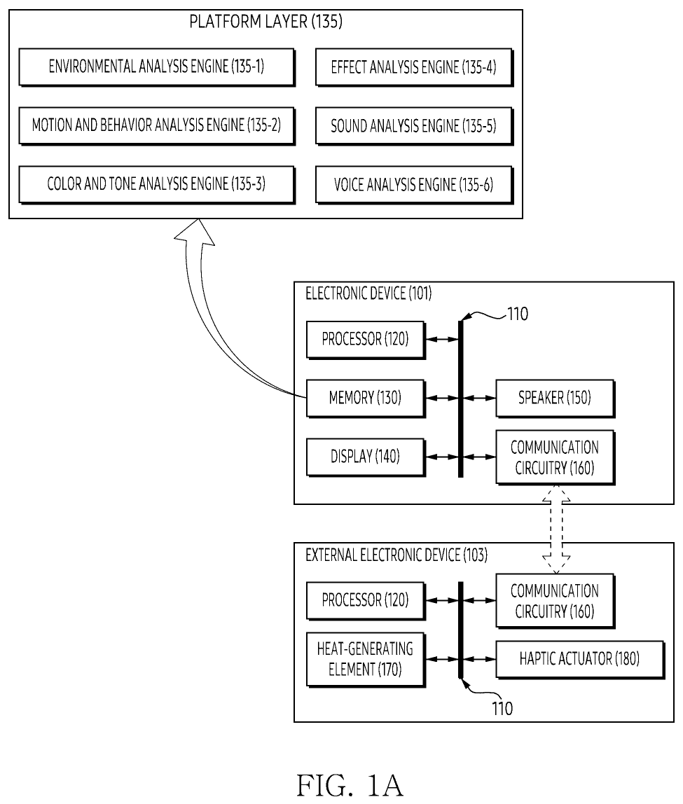

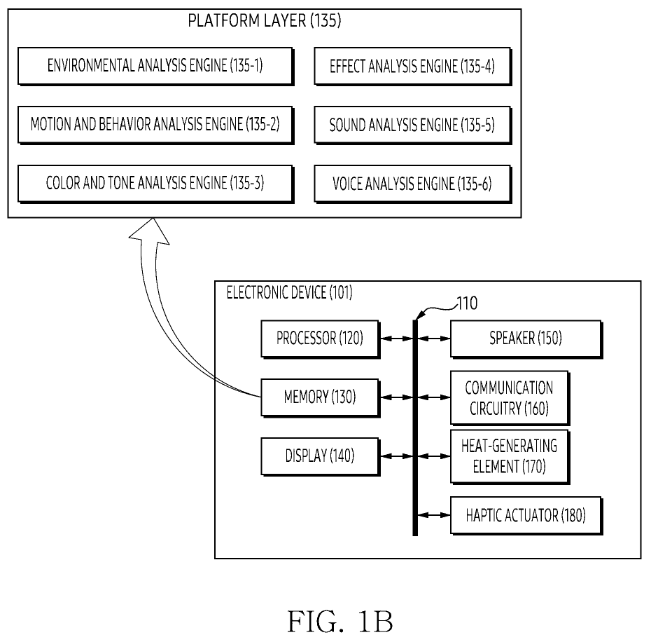

FIG. 1A illustrates an example of a block diagram of an electronic device according to an embodiment. FIG. 1B illustrates an example of a block diagram of an electronic device according to an embodiment. An electronic device 101 of FIG. 1A and/or FIG. 1A may include a terminal owned by a user. For example, the terminal may include a personal computer (PC) such as a laptop and a desktop, a smartphone, a smartpad, a tablet PC, a smartwatch, and a smart accessory such as a head-mounted device (HMD). For example, the terminal may include a device for an augmented reality, such as an augmented reality (AR) glass. For example, the terminal may include a device for a virtual reality (VR), an extended reality (XR), and/or a mixed reality (MR).

Referring to FIGS. 1A and 1B, according to an embodiment, the electronic device 101 may include at least one of a processor 120, memory 130, a display 140, a speaker 150, communication circuitry 160, a heat-generating element 170, and a haptic actuator 180. The processor 120, the memory 130, the display 140, the speaker 150, the communication circuitry 160, the heat-generating element 170, and the haptic actuator 180 may be electronically and/or operably coupled with each other by an electronical component such as a communication bus 110. Hereinafter, hardware being operably coupled may mean that a direct connection or an indirect connection between the hardware is established by wire or wirelessly, so that second hardware among the hardware is controlled by first hardware. Although illustrated in different blocks, an embodiment is not limited thereto. A portion (e.g., at least a portion of the processor 120, the memory 130, and the communication circuitry 150) of the hardware of FIG. 1A and/or FIG. 1B may be included in a single integrated circuit like a system on a chip (SoC). A type and/or the number of hardware included in the electronic device 101 is not limited as illustrated in FIGS. 1A and/or 1B. For example, the electronic device 101 may include only a portion of the hardware illustrated in FIG. 1A and/or FIG. 1B.

According to an embodiment, the electronic device 101 may include hardware for processing data based on one or more instructions. The hardware for processing data may include, for example, an arithmetic and logic unit (ALU), a floating point unit (FPU), a field programmable gate array (FPGA), a central processing unit (CPU), and/or an application processor (AP). The processor 120 may have a structure of a single-core processor, or may have a structure of a multi-core processor such as a dual core, a quad core, a hexa core, and an octa core.

The memory 130 of the electronic device 101 may include a hardware component for storing data and/or instruction inputted and/or outputted to the processor 120 of the electronic device 101. For example, the memory 130 may include volatile memory such as a random-access memory (RAM) and/or non-volatile memory such as a read-only memory (ROM). For example, the volatile memory may include at least one of a dynamic RAM (DRAM), a static RAM (SRAM), Cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, a solid state drive (SSD), and an embedded multi-media card (eMMC).

According to an embodiment, the memory 130 may include a platform layer 135. For example, programs distinguished by the platform layer 135 may be executed by the processor 120 of the electronic device 101. The programs separated by different blocks of FIG. 1A and/or 1B may be stored in the memory 130 of the electronic device 101 based on a format executable by the processor 120 of the electronic device 101. For example, in the platform layer 135, programs (e.g., an environmental analysis engine 135-1, a motion and behavior analysis engine 135-2, a color and tone analysis engine 135-3, an effect analysis engine 135-4, a sound analysis engine 135-5, and/or a voice analysis engine 135-6) designed to target any one of the programs classified as a layer different from the platform layer 135 may be classified. The programs classified as the platform layer 135 may provide an application programming interface (API) that is executable based on another program.

According to an embodiment, the electronic device 101 may include haptic information for outputting haptic feedback in the memory 130. For example, the haptic information may include information for controlling the heat-generating element 170 and/or the haptic actuator 180 included in an external electronic device 103 and/or the electronic device 101. For example, the haptic information may be obtained based on at least a portion of a media content executed by the electronic device 101. “Based on” as used herein covers based at least on.

According to an embodiment, the display 140 of the electronic device 101 may output visualized information to the user. For example, the display 140 may output visualized information to the user by being controlled by the processor 120 including a circuit such as a graphic processing unit (GPU). The display 140 may include a flat panel display (FPD) and/or electronic paper. The FPD may include a liquid crystal display (LCD), a plasma display panel (PDP), and/or one or more light emitting diodes (LEDs). The LED may include an organic LED (OLED).

According to an embodiment, the speaker 150 of the electronic device 101 may include at least one voice coil that provides a vibration to a diaphragm in the speaker 150 and a magnet capable of forming a magnetic field. When current flows through the at least one voice coil, a magnetic field formed by the voice coil may vibrate the voice coil by interacting with the magnetic field formed by the magnet. The diaphragm connected to the voice coil may vibrate based on the vibration of the voice coil. The speaker 150 may output an audio signal based on the vibration of the diaphragm.

According to an embodiment, the communication circuitry 160 of the electronic device 101 may include a hardware component for supporting transmission and/or reception of an electrical signal between the external electronic device 103. The communication circuitry 160 may include the hardware component for supporting the transmission and/or the reception of the electrical signal between the electronic device 101 and the external electronic device 103. For example, the communication circuitry 160 may include at least one of a MODEM, an antenna, and an optic/electronic (O/E) converter. The communication circuitry 160 may support the transmission and/or reception of an electrical signal based on various types of protocols such as an ethernet, a local area network (LAN), a wide area network (WAN), a wireless fidelity (WiFi), a Bluetooth, a Bluetooth low energy (BLE), a ZigBee, a long term evolution (LTE), and a 5th generation new radio (5G NR).

For example, the communication circuitry 160 may include an HDMI, a USB interface, an SD card interface, or an audio interface in association with a connection terminal such as a high definition multimedia interface (HDMI) connector, a universal serial bus (USB) connector, an SD card connector, or an audio connector. The electronic device 101 may be electronically and/or operably connected, directly or indirectly, to the external electronic device 103 based on the examples.

Referring to FIG. 1A, according to an embodiment, the electronic device 101 and the external electronic device 103 may be connected through the communication circuitry 160. For example, the electronic device 101 may transmit haptic information obtained based on a media content to the external electronic device 103 connected through the communication circuitry 160. The external electronic device 103 that receives the haptic information may operate the heat-generating element 170 and/or the haptic actuator 180 included in the external electronic device 103. For example, the external electronic device 103 may control a temperature of the heat-generating element 170. For example, the external electronic device 103 may control a vibration of the haptic actuator 180.

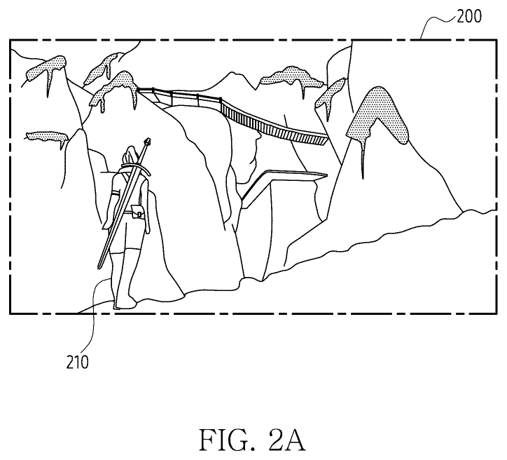

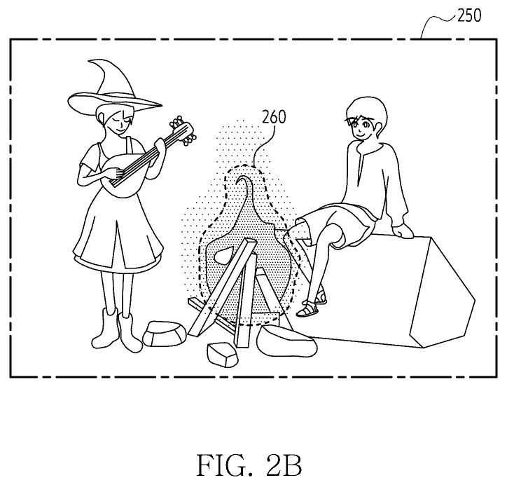

Referring to FIG. 1A and/or FIG. 1B, according to an embodiment, the external electronic device 103 and/or the electronic device 101 may include the heat-generating element 170 or the haptic actuator 180. The heat-generating element 170 or the haptic actuator 180 may change a temperature or generate a vibration by being controlled by the processor 120. For example, the heat-generating element 170 may include a peltier element. For example, the heat-generating element 170 may change a temperature based on the peltier effect. For example, the peltier effect may be an effect of causing a change in the temperature by using a movement of heat generated by a flow of current. For example, the haptic actuator 180 may include a piezoelectric element. For example, the haptic actuator 180 may operate at a designated frequency and a designated amplitude controlled by the processor 120. For example, the haptic actuator 180 may output haptic feedback to a user by having the designated frequency, the designated amplitude, and/or a designated period. For example, the designated frequency, the designated amplitude, and/or the designated period may be obtained based on a media content. Operation of obtaining haptic information for outputting haptic feedback by the heat-generating element 170 and/or the haptic actuator 180 will be described later in FIGS. 2A to 4.

Referring to FIGS. 1A to 1B, according to an embodiment, the electronic device 101 may output the media content through the speaker 150 and/or the display 140. While outputting the media content, the electronic device 101 may obtain haptic information for outputting haptic feedback synchronized with the media content. For example, while outputting the media content, the electronic device 101 may obtain haptic information stored in the memory 130. For example, the haptic feedback may be related to heat or a vibration adjusted by a component included in the electronic device 101. The electronic device 101 may obtain the haptic information based on the media content.

According to an embodiment, the electronic device 101 may execute the color and tone analysis engine 135-3 in response to a call of a designated API based on an execution of a software application for outputting a media content. The electronic device 101 may analyze a frame of the media content based on the execution of the color and tone analysis engine 135-3. For example, the electronic device 101 may obtain haptic information from the frame of the media content based on at least one of reference colors for forming a color space. The electronic device 101 may obtain the haptic information based on a representative value of the reference colors. For example, the representative value may include a maximum value, a minimum value, a mode value, a median value, and an average value. For example, the electronic device 101 may obtain an average value for colors of pixels in the frame based on at least one of the reference colors. The electronic device 101 may obtain haptic information based on the average value for the colors of the pixels in the frame. For example, the reference colors for forming the color space may include red, green, blue (RGB), cyan, magenta, yellow (CMYK), hue, saturation, value (HSV), and YUV. The YUV may be configured based on a component Y, which is a luminance component, component U, which is a blue chromatic aberration component, and component V, which is a red chromatic aberration component. For example, the electronic device 101 may obtain haptic information for adjusting a temperature based on the RGB. For example, the electronic device 101 may obtain the RGB value corresponding to each of the pixels based on the colors of the pixels. The RGB value may include a red value (an R value) for displaying a red color, a green value (a G value) for displaying a green color, and a blue value (a B value) for displaying a blue color. The electronic device 101 may identify the RGB value corresponding to each of the pixels included in the designated area. The electronic device 101 may identify an average value of the RGB value of the pixels included in the designated area. The electronic device 101 may obtain haptic information for outputting a first temperature based on identifying the R value of the average RGB value that is relatively higher than the B value of the average RGB value. The electronic device 101 may obtain haptic information for outputting a second temperature based on identifying the B value of the average RGB value that is relatively higher than the R value of the average RGB value. For example, the first temperature may include a higher temperature than the second temperature. However, it is not limited thereto.

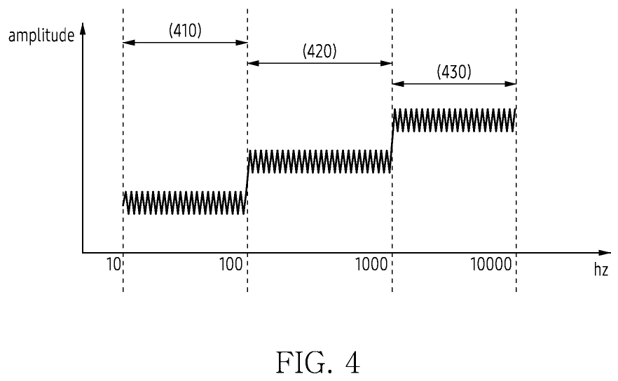

According to an embodiment, the electronic device 101 may identify an audio signal included in a media content. The electronic device 101 may execute the sound analysis engine 135-5 and/or the voice analysis engine 135-6 in response to a call of a designated API based on an execution of a software application for outputting the media content. The electronic device 101 may analyze the audio signal included in the media content based on the execution of the sound analysis engine 135-5 and/or the voice analysis engine 135-6. The electronic device 101 may identify frequency distribution of the audio signal. For example, the electronic device 101 may obtain haptic information corresponding to a first designated range based on an audio signal identified as a frequency in the first designated range. The electronic device 101 may obtain haptic information corresponding to a second designated range based on an audio signal identified as a frequency in the second designated range. The electronic device 101 may obtain haptic information corresponding to a third designated range based on an audio signal identified as a frequency in the third designated range. For example, the first designated range may include approximately 10 to 100 hertz (hz). For example, the second designated range may include approximately 100 to 1,000 hertz. For example, the third designated range may include approximately 1,000 to 10,000 hertz. For example, the electronic device 101 may obtain haptic information for outputting a vibration of a first intensity based on identifying an audio signal in the first designated range. For example, the electronic device 101 may obtain haptic information for outputting a vibration of a second intensity based on identifying an audio signal in the second designated range. For example, the electronic device 101 may obtain haptic information for outputting a vibration of a third intensity based on identifying an audio signal in the third designated range. However, it is not limited thereto. A description related to the audio signal will be described later in FIG. 4.

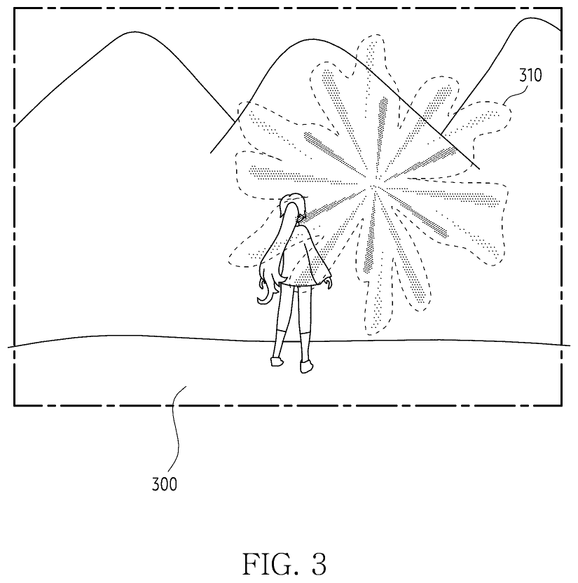

According to an embodiment, the electronic device 101 may execute the environmental analysis engine 135-1 and/or the effect analysis engine 135-4 in response to a call of a designated API based on an execution of a software application for outputting a media content. The electronic device 101 may analyze frames included in the media content based on an execution of the environmental analysis engine 135-1 and/or the effect analysis engine 135-4. According to an embodiment, the electronic device 101 may identify frames included in a media content. The electronic device 101 may perform scene analysis for the frames included in the media content. For example, the scene analysis may be performed based on the environmental analysis engine 135-1 and/or the effect analysis engine 135-4. The electronic device 101 may obtain haptic information based on the scene analysis. For example, the scene analysis may be related to a change in a screen and an environment of a scene displayed in the screen. For example, the scene analysis may be related to the vibration of a screen and a movement of the screen. For example, the scene analysis may include a designated event. For example, the designated event may include a visual effect such as a firecracker effect, a fog effect, and/or a laser effect displayed in the screen. The electronic device 101 may obtain haptic information for controlling the haptic actuator 180 based on the scene analysis. A description related to a screen analysis will be described later in FIGS. 2A to 2B. A description related to the designated event will be described later in FIG. 3.

According to an embodiment, the electronic device 101 may execute the motion and behavior analysis engine 135-2 in response to a call of a designated API based on an execution of a software application for outputting a media content. According to an embodiment, the electronic device 101 may analyze a motion and/or behavior of a visual object (e.g., a virtual object) included in the media content based on an execution of the motion and behavior analysis engine 135-2. The electronic device 101 may identify a motion and/or behavior of the visual object. For example, the electronic device 101 may obtain haptic information based on the motion or the behavior of the visual object. For example, the electronic device 101 may identify a walking motion of the visual object. For example, the electronic device 101 may obtain haptic information for controlling the haptic actuator 180 of an external electronic device based on the motion of the visual object. For example, the electronic device 101 may obtain vibration information in response to a portion (e.g., a foot of a virtual object) of the visual object touching the ground displayed in the media content. The electronic device 101 may transmit haptic information including the vibration information to an external electronic device based on obtaining the vibration information. An operation of analyzing the motion and/or the behavior of the visual object will be described later in FIG. 2A.

According to an embodiment, the electronic device 101 may analyze a media content outputted by the electronic device 101 based on an execution of the environmental analysis engine 135-1, the motion and behavior analysis engine 135-2, the color and tone analysis engine 135-3, the effect analysis engine 135-4, the sound analysis engine 135-5, and/or the voice analysis engine 135-6 included in the platform layer 135. According to an embodiment, the electronic device 101 may analyze the media content based on hardware (e.g., a neural processing unit (NPU) and/or a graphic processing unit (GPU)) for performing computation related to artificial intelligence, a software application and/or an external electronic device (e.g., a server related to the artificial intelligence) for providing a function related to the artificial intelligence. The electronic device 101 may obtain haptic information for outputting haptic feedback based on the analysis of the media content. For example, based on data obtained based on the analysis of the media content, the electronic device 101 may obtain haptic information corresponding to the obtained data from the memory.

According to an embodiment, the electronic device 101 may obtain haptic information based on a movement of a screen. For example, the electronic device 101 may obtain haptic information for outputting haptic feedback corresponding to the movement of the screen. For example, the electronic device 101 may obtain haptic information for outputting from left to right when outputting vibration feedback, based in the screen moving from left to right. For example, the vibration feedback outputted from left to right may include vibration feedback generated based on a single external electronic device 103. For example, the vibration feedback outputted from the left to the right may include vibration feedback generated based on a plurality of external electronic devices. For example, when the external electronic device is a wearable device such as gloves worn by a user, an operation in which vibration feedback is generated from a first external electronic device worn on a left hand to a second external electronic device worn on a right hand may be included. However, it is not limited thereto.

According to an embodiment, the electronic device 101 may obtain haptic information for representing a texture. The electronic device 101 may obtain haptic information for controlling haptic feedback of the haptic actuator 180. The haptic information for representing the texture may be related to a frequency for controlling the haptic actuator 180. For example, the haptic information for representing the texture may be related to an amplitude and/or a period of the frequency for controlling the haptic actuator 180.

According to an embodiment, the electronic device 101 may obtain haptic information for adjusting heat generated by the heat-generating element 170. For example, the haptic information for adjusting heat generated by the heat-generating element 170 may include information related to current and/or voltage for controlling the heat-generating element 170. For example, the electronic device 101 may instruct the external electronic device to output a relatively high temperature based on haptic information indicating a relatively high current flow.

According to an embodiment, the electronic device 101 may identify a plurality of heat-generating elements included in the external electronic device 103. The electronic device 101 may transmit haptic information for controlling each of the heat-generating elements to the external electronic device 103. For example, the electronic device 101 may identify information related to a position of the plurality of heat-generating elements included in the external electronic device 103. The electronic device 101 may transmit haptic information for controlling each of the plurality of heat-generating elements based on identifying the information related to the position of the plurality of heat-generating elements. For example, the electronic device 101 may obtain haptic information for controlling each of the plurality of heat-generating elements based on a media content. For example, the electronic device 101 may identify first heat-generating elements disposed in a first area among the plurality of heat-generating elements. For example, the first area may include a left area of the external electronic device 103. The electronic device 101 may obtain first haptic information for controlling the first heat-generating elements. The electronic device 101 may identify second heat-generating elements disposed in a second area among the plurality of heat-generating elements. For example, the second area may include a right area of the external electronic device 103. The electronic device 101 may obtain second haptic information for controlling the second heat-generating elements. The electronic device 101 may transmit the first haptic information and the second haptic information to the external electronic device 103. The electronic device 101 may sequentially transmit the first haptic information and the second haptic information. For example, the electronic device 101 may sequentially change temperatures of the first area and the second area by sequentially transmitting the first haptic information and the second haptic information. The first area and the second area are examples and are not limited thereto. A position of the first area and the second area are not limited. The number of the areas (e.g., the first area and/or the second area) is not limited.

According to an embodiment, the electronic device 101 may obtain haptic information stored in the memory 130. For example, the haptic information stored in the memory 130 may include first information for controlling the heat-generating element 170. For example, the haptic information stored in the memory 130 may include second information for controlling the haptic actuator 180. For example, the haptic information may be generated based on information obtained based on hardware (e.g., the neural processing unit (NPU), and/or the graphic processing unit (GPU)) to perform computation related to artificial intelligence, software and/or an external electronic device (e.g., the server related to the artificial intelligence) to provide a function related to the artificial intelligence.

According to an embodiment, the electronic device 101 may analyze a media content based on programs (e.g., the environmental analysis engine 135-1, the motion and behavior analysis engine 135-2, the color and tone analysis engine 135-3, the effect analysis engine 135-4, the sound analysis engine 135-5, and/or the voice analysis engine 135-6) included in the platform layer 135. The electronic device 101 may obtain haptic information as illustrated in Table 1 below based on analyzing the media content.

TABLE 1

| Component | Program being | Component being |
|---|---|---|
| being analyzed | executed | controlled |
| Environment | Environmental analysis | Heat-generating |
| | engine 135-1 | element 170 |
| Motion and | Motion and behavior analysis | Haptic actuator 180 |
| behavior | engine 135-2 | |
| Color and tone | Color and Tone analysis | Heat-generating |
| | engine 135-3 | element 170 |
| Effect | Effect analysis engine 135-4 | Heat-generating element |
| | | 170 and Haptic actuator |
| | | 180 |
| Vibration of | Effect analysis engine 135-4 | Haptic actuator 180 |
| a screen | | |
| Moving a screen | Effect analysis engine 135-4 | Haptic actuator 180 |
| Sound | Sound analysis engine 135-5 | Haptic actuator 180 |
| Voice | Voice analysis engine 135-6 | Haptic actuator 180 |

According to an embodiment, the electronic device 101 may analyze a background of a screen in the screen displayed based on a media content. The electronic device 101 may execute the environmental analysis engine 135-1 for analyzing the background of the screen. The electronic device 101 may obtain haptic information for representing an environment of the screen based on the execution of the environmental analysis engine 135-1. The electronic device 101 may obtain haptic information for representing the environment of the screen and controlling the heat-generating element 170.

According to an embodiment, the electronic device 101 may analyze a motion and/or a behavior of a visual object included in a media content. The electronic device 101 may execute the motion and behavior analysis engine 135-2 for analyzing the motion and/or the behavior of the visual object. The electronic device 101 may obtain haptic information for representing the motion and/or the behavior of the visual object based on the execution of the motion and behavior analysis engine 135-2. For example, the haptic information for representing the motion and/or the behavior of the visual object may include haptic information for controlling the haptic actuator 180.

According to an embodiment, the electronic device 101 may analyze a color and/or a tone of a screen displayed based on a media content. For example, the electronic device 101 may execute the color and tone analysis engine 135-3 for analyzing the color and/or the tone of the screen. The electronic device 101 may obtain haptic information for representing the color and/or the tone of the screen based on the execution of the color and tone analysis engine 135-3. For example, the haptic information for representing the color and/or the tone of the screen may include haptic information for controlling the heat-generating element 170.

According to an embodiment, the electronic device 101 may identify a visual effect outputted while outputting a media content. For example, the visual effect may include a visual effect such as a firecracker effect, a fog effect, and/or a laser effect. The visual effect may include a visual effect set to output haptic feedback. The electronic device 101 may execute the effect analysis engine 135-4 for analyzing the visual effect based on identifying the visual effect. The electronic device 101 may obtain haptic information for representing the visual effect based on the execution of the effect analysis engine 135-4. For example, the haptic information for representing the visual effect may include haptic information for controlling the heat-generating element 170 and/or the haptic actuator 180.

According to an embodiment, the electronic device 101 may perform a scene analysis on frames included in a media content. The electronic device 101 may perform the scene analysis based on a vibration of the screen and/or a movement of the screen. The electronic device 101 may execute the effect analysis engine 135-4 for the scene analysis. The electronic device 101 may obtain haptic information for representing the vibration of the screen and/or the movement of the screen based on the execution of the effect analysis engine 135-4. The haptic information for representing the vibration of the screen and/or the movement of the screen may include haptic information for controlling the haptic actuator 180.

According to an embodiment, the electronic device 101 may analyze a sound and/or a voice outputted based on a media content. The electronic device 101 may execute the sound analysis engine 135-5 for analyzing the sound. The electronic device 101 may obtain haptic information for representing the sound based on the execution of the sound analysis engine 135-5. For example, the haptic information for representing the sound may include haptic information for controlling the haptic actuator 180.

According to an embodiment, the electronic device 101 may analyze a voice outputted based on a media content. The electronic device 101 may execute the voice analysis engine 135-6 for analyzing the voice. The electronic device 101 may obtain haptic information for representing the voice based on the execution of the voice analysis engine 135-6. For example, the haptic information for representing the voice may include haptic information for controlling the haptic actuator 180.

According to an embodiment, the electronic device 101 may transmit haptic information to the external electronic device 103. The electronic device 101 may identify components included in the external electronic device 103. For example, the electronic device 101 connected to the external electronic device 103 through the communication circuitry 160 may obtain capability information related to components for outputting haptic feedback included in the external electronic device 103 through the communication circuitry 160. For example, the electronic device 101 may transmit a first signal for obtaining the capability information to the external electronic device 103. The electronic device 101 may receive a second signal including the capability information indicating whether to include at least one of the heat-generating element 170 or the haptic actuator 180 from the external electronic device 103. The electronic device 101 may identify the capability information based on receiving the second signal.

According to an embodiment, the electronic device 101 may identify capability information of the external electronic device 103. For example, the electronic device 101 may identify capability information for haptic feedback supported by the external electronic device 103. The electronic device 101 may selectively transmit haptic information based on identifying the capability information. For example, the electronic device 101 may transmit the first information, which is haptic information for controlling the heat-generating element 170, to the external electronic device 103 based on the fact that the external electronic device 103 includes the heat-generating element 170 among the heat-generating element 170 and the haptic actuator 180. For example, the electronic device 101 may transmit the second information for controlling the haptic actuator 180 to the external electronic device 103 based on the fact that the external electronic device 103 includes the haptic actuator 180 among the heat-generating element 170 and the haptic actuator 180.

According to an embodiment, the electronic device 101 may identify the first information for controlling the heat-generating element 170 included in the haptic information. The electronic device 101 may identify the second information for controlling the haptic actuator 180, included in the haptic information. The electronic device 101 may change the first information for controlling the heat-generating element 170 into third information for controlling the haptic actuator 180, based on identifying the haptic actuator 180 among the heat-generating element 170 and the haptic actuator 180. For example, the electronic device 101 may obtain the third information corresponding to the first information. For example, the electronic device 101 may change the first information for adjusting the heat-generating element 170 to the first temperature into the third information for outputting the vibration of the first intensity. The electronic device 101 may transmit the second information and the third information to the external electronic device 103 based on changing the first information into the third information. The external electronic device 103 receiving the second information and the third information may output haptic feedback based on at least one of the second information or the third information.

According to an embodiment, the electronic device 101 may identify the second information for controlling the haptic actuator 180, included in the haptic information. The electronic device 101 may identify the first information for controlling the heat-generating element 170 included in the haptic information. The electronic device 101 may change the second information for controlling the haptic actuator 180 into fourth information for controlling the heat-generating element 170 based on identifying the heat-generating element 170 among the heat-generating element 170 and the haptic actuator 180. For example, the electronic device 101 may obtain the fourth information corresponding to the second information. The electronic device 101 may transmit the fourth information to the external electronic device 103 based on obtaining the fourth information.

According to an embodiment, the electronic device 101 may obtain haptic information for outputting haptic feedback synchronized with a media content. For example, the electronic device 101 may adjust the first information for controlling the heat-generating element 170 included in the haptic information. For example, the electronic device 101 may adjust the first information based on capability information of the external electronic device 103. The capability information may be related to a specification of the heat-generating element 170 and/or the haptic actuator 180. For example, the electronic device 101 may adjust haptic feedback outputted by the heat-generating element 170 based on capability information of the heat-generating element 170 included in the external electronic device 103. The electronic device 101 may transmit the adjusted first information to the external electronic device 103. According to an embodiment, the electronic device 101 may adjust the second information for controlling the haptic actuator 180 included in the haptic information. For example, the electronic device 101 may adjust haptic feedback outputted by the haptic actuator 180 based on capability information of the haptic actuator 180 included in the external electronic device 103. The electronic device 101 may transmit the adjusted second information to the external electronic device 103 based on adjusting the second information included in the haptic information.

As described above, according to an embodiment, the electronic device 101 may obtain haptic information for outputting haptic feedback synchronized with a media content in a state of outputting the media content. The electronic device 101 may identify capability information for haptic feedback supported by the external electronic device 103 connected through the communication circuitry 160. The electronic device 101 may transmit haptic information adjusted by the capability information indicating whether the external electronic device 103 includes at least one of the heat-generating element 170 or the haptic actuator 180. The electronic device 101 may enhance a user experience of the electronic device 101 and/or the external electronic device 103 by transmitting the adjusted haptic information.

FIG. 2A illustrates an example of a media content outputted by an electronic device according to an embodiment. FIG. 2B illustrates an example of a media content outputted by an electronic device according to an embodiment. An electronic device 101 of FIGS. 2A to 2B may include the electronic device 101 of FIG. 1A and/or 1B. Operations of FIGS. 2A to 2B may be executed by the processor 120 of FIGS. 1A and/or 1B.

Referring to FIG. 2A and/or FIG. 2B, according to an embodiment, the electronic device 101 may output a media content through a speaker (e.g., the speaker 150 of FIG. 1A and/or FIG. 1B) and a display (e.g., the display 140 of FIG. 1A, and/or FIG. 1B). The electronic device 101 may obtain haptic information for outputting haptic feedback synchronized with the media content in a state of outputting the media content. FIG. 2A and/or FIG. 2B may be an example of the electronic device 101 performing a scene analysis for obtaining the haptic information.

Referring to FIG. 2A, according to an embodiment, the electronic device 101 may output a media content. The electronic device 101 may display a screen 200 related to the media content through a display. For example, the electronic device 101 may perform a scene analysis of the screen 200. For example, the scene analysis may include an object recognition displayed in the screen 200, a feature point analysis, and/or a scene analysis based on an artificial intelligence model. The electronic device 101 may perform the scene analysis based on a frame displayed in the screen 200. For example, the electronic device 101 may identify an environment displayed in the screen 200. For example, an example of FIG. 2A may include an example of a media content including an icy mountain. The electronic device 101 may obtain haptic information for representing the screen 200 based on identifying the icy mountain in the screen 200. For example, the electronic device 101 may obtain haptic information for adjusting a heat-generating element (e.g., the heat-generating element 170 of FIG. 1A) of an external electronic device (e.g., the external electronic device 103 of FIG. 1A). For example, the electronic device 101 may obtain temperature information for outputting haptic feedback of a designated temperature. The electronic device 101 may transmit haptic information including the temperature information to the external electronic device based on obtaining the temperature information.

According to an embodiment, the electronic device 101 may identify a visual object 210 displayed in the screen 200. The electronic device 101 may identify a motion of the visual object 210. For example, the electronic device 101 may obtain haptic information based on the motion or a movement of the visual object 210. For example, the electronic device 101 may identify a walking motion of the visual object 210. For example, the electronic device 101 may obtain haptic information for controlling a haptic actuator (e.g., the haptic actuator 180 of FIG. 1A) of the external electronic device based on the motion of the visual object 210. For example, the electronic device 101 may obtain vibration information in response to a portion (e.g., a foot) of the visual object 210 touching the ground displayed in the screen. The electronic device 101 may transmit haptic information including the vibration information to the external electronic device based on obtaining the vibration information.

Referring to FIG. 2B, according to an embodiment, the electronic device 101 may output a media content. The electronic device 101 may display a screen 250 related to the media content. The electronic device 101 may identify a visual object 260 included in the screen 250. For example, the electronic device 101 may obtain haptic information related to the visual object 260 based on identifying the visual object 260. For example, the haptic information related to the visual object 260 may be related to controlling a heat-generating element of the external electronic device. The visual object 260 may be directly or indirectly related to a temperature, such as fire, water, or ice. The electronic device 101 may obtain haptic information for representing the visual object 260 based on identifying the visual object 260 related to the temperature. For example, the electronic device 101 may obtain temperature information for representing the fire in order to represent a temperature relatively higher than that of ice. The electronic device 101 may transmit the temperature information to the external electronic device.

As described above, according to an embodiment, the electronic device 101 may output a media content through a speaker and a display. While outputting a media content, the electronic device 101 may perform a scene analysis of the media content. The electronic device 101 may obtain haptic information for controlling a heat-generating element or a haptic actuator based on the scene analysis. The electronic device 101 may transmit the haptic information to an external electronic device. The electronic device 101 may enhance a user experience of the electronic device 101 or the external electronic device by transmitting the haptic information obtained based on the scene analysis to the external electronic device.

FIG. 3 illustrates an example of a media content outputted by an electronic device according to an embodiment. An electronic device 101 of FIG. 3 may include the electronic device 101 of FIGS. 1A, 1B, 2A, and/or 2B. Operations of FIG. 3 may be executed by the processor 120 of FIGS. 1A and/or 1B.

Referring to FIG. 3, according to an embodiment, the electronic device 101 may output a media content through a speaker (e.g., the speaker 150 of FIGS. 1A and/or 1B) and a display (e.g., the display 140 of FIGS. 1A and/or 1B). The electronic device 101 may display a screen 300 related to a media content. According to an embodiment, the electronic device 101 may identify a designated event displayed in the screen 300 based on displaying the screen 300. For example, the designated event may include a visual effect such as a firecracker effect, a fog effect, and/or a laser effect, displayed in the screen 300. The designated event may include a visual effect set to output haptic feedback among the visual effects displayed through the screen 300.

According to an embodiment, the electronic device 101 may obtain haptic information for outputting haptic feedback for representing the designated event based on identifying the designated event. For example, the haptic information for outputting the haptic feedback may include information for controlling a haptic actuator (e.g., the haptic actuator 180 of FIGS. 1A and/or 1B).

According to an embodiment, the electronic device 101 may identify a visual object 310 related to the designated event. The electronic device 101 may obtain haptic information corresponding to the visual object 310 based on identifying the visual object 310 related to the designated event. For example, the electronic device 101 may obtain haptic information based on a size of the visual object 310. For example, the electronic device 101 may obtain haptic information for generating stronger vibration feedback as the size of the visual object 310 increases.

For example, the electronic device 101 may obtain haptic information based on at least one of reference colors of the visual object 310. For example, the electronic device 101 may obtain the haptic information based on a representative value of the reference colors. For example, the representative value may include a maximum value, a minimum value, a mode value, a median value, and an average value. The electronic device 101 may obtain the haptic information based on colors of pixels forming the visual object 310. For example, the electronic device 101 may identify RGB values of the pixels forming the visual object 310. The electronic device 101 may obtain haptic information for adjusting a temperature of a heat-generating element based on identifying that an R value among the identified RGB values is relatively larger than a B value. The electronic device 101 may obtain haptic information for outputting a relatively higher temperature of the heat-generating element based on identifying that the R value is relatively larger than the B value, compared to a case where the B value is identified. For example, the electronic device 101 may identify the RGB value of the pixels forming the visual object 310. The electronic device 101 may obtain haptic information based on the RGB value of the pixels forming the visual object 310. For example, the electronic device 101 may obtain an average value of the R value, a G value, and the B value constituting the RGB value obtained based on the pixels forming the visual object 310. The electronic device 101 may obtain haptic information based on an average value of each of the R value, the G value, and the B value. For example, the electronic device 101 may identify the average value of the R value forming the visual object 310 as a value larger than the average value of the B value forming the visual object 310. The electronic device 101 may obtain haptic information for outputting a high temperature for representing the visual object 310, based on identifying that the average value of the R value is a value larger than the average value of the B value. For example, the electronic device 101 may identify the average value of the B value forming the visual object 310 as a value larger than the average value of the R value forming the visual object 310. The electronic device 101 may obtain haptic information for outputting a low temperature for representing the visual object 310, based on identifying that the average value of the value B is a value larger than the average value of the value R. For example, the electronic device 101 may obtain haptic information related to a designated temperature corresponding to the average value of the R value or the average value of the B value. The electronic device 101 may transmit haptic information obtained based on the RGB value forming the visual object 310 to an external electronic device.

As described above, according to an embodiment, the electronic device 101 may output a media content. The electronic device 101 may identify a designated event in a state of outputting the media content. The electronic device 101 may identify the visual object 310 related to the designated event. The electronic device 101 may obtain haptic information related to the visual object 310 based on identifying the visual object 310. The electronic device 101 may obtain haptic information for representing the visual object 310. The electronic device 101 may transmit haptic information for representing the visual object 310 to the external electronic device. The electronic device 101 may enhance a user experience of the electronic device 101 and/or the external electronic device by transmitting the haptic information for representing the visual object 310 to the external electronic device.

FIG. 4 illustrates an example of a frequency of an audio signal for obtaining haptic information according to an embodiment. An electronic device 101 of FIG. 4 may include the electronic device 101 of FIGS. 1A, 1B, 2A, 2B, and/or 3. Operations of FIG. 4 may be executed by the processor 120 of FIGS. 1A and/or 1B.

Referring to FIG. 4, according to an embodiment, the electronic device 101 may output a media content through a speaker (e.g., the speaker 150 of FIGS. 1A and/or 1B) and a display (e.g., the display 140 of FIGS. 1A and/or 1B). The electronic device 101 may obtain haptic information for outputting haptic feedback synchronized with the media content in a state of outputting the media content. An example of FIG. 4 may include an example of an audio signal outputted through the speaker.

According to an embodiment, the electronic device 101 may identify an audio signal of a first frequency 410. For example, the first frequency 410 may include a frequency between approximately 10 to 100 hertz. The electronic device 101 may obtain haptic information including haptic data corresponding to the first frequency 410 based on identifying the audio signal of the first frequency 410. For example, the electronic device 101 may obtain first haptic information for representing an audio signal corresponding to the first frequency 410. The first haptic information may include information for outputting a haptic actuator (e.g., the haptic actuator 180 of FIGS. 1A and/or 1B) with a first intensity. For example, the electronic device 101 may identify an audio signal of a second frequency 420. For example, the second frequency 420 may include approximately 100 to approximately 1,000 hertz. The electronic device 101 may obtain haptic information including haptic data corresponding to the second frequency 420 based on identifying the audio signal of the second frequency 420. For example, the electronic device 101 may obtain second haptic information for representing an audio signal corresponding to the second frequency 420. For example, the second haptic information may include information for outputting the haptic actuator at a second intensity. For example, the electronic device 101 may identify an audio signal of a third frequency 430. For example, the third frequency 430 may include approximately 1,000 to 10,000 hertz. The electronic device 101 may obtain haptic information including haptic data corresponding to the third frequency 430, based on identifying the audio signal of the third frequency 430. For example, the electronic device 101 may obtain third haptic information for representing an audio signal corresponding to the third frequency 430. For example, the third haptic information may include information for outputting the haptic actuator at a third intensity. For example, the first intensity may include a relatively weak intensity compared to the second intensity. For example, the second intensity may include a relatively stronger intensity than the first intensity and a relatively weak intensity than the third intensity. For example, the third intensity may include a relatively strong intensity compared to the first intensity and the second intensity. The intensity may mean a vibration intensity of a haptic actuator. The electronic device 101 may transmit the haptic information obtained based on the audio signal to an external electronic device. For example, the electronic device 101 may transmit the haptic information obtained based on the frequency of the audio signal to the external electronic device.

According to an embodiment, the electronic device 101 may obtain haptic information for controlling the haptic actuator based on a frequency of an audio signal outputted through the speaker. The electronic device 101 may store the haptic information in memory (e.g., the memory 130 of FIGS. 1A and/or 1B) based on obtaining the haptic information. The electronic device 101 may load haptic information stored in the memory based on the frequency of the identified audio signal. The electronic device 101 may transmit the loaded haptic information to the external electronic device.

As described above, according to an embodiment, the electronic device 101 may output a media content through the speaker and the display. The electronic device 101 may identify an audio signal included in the media content in a state of outputting the media content. The electronic device 101 may identify a frequency of the audio signal. The electronic device 101 may obtain haptic information for outputting haptic feedback corresponding to the frequency based on the frequency of the audio signal. The electronic device 101 may transmit the haptic information to the external electronic device based on obtaining the haptic information for outputting the haptic feedback. The electronic device 101 may enhance a user experience of the electronic device 101 and/or the external electronic device by transmitting the haptic information obtained based on the audio signal to the external electronic device.

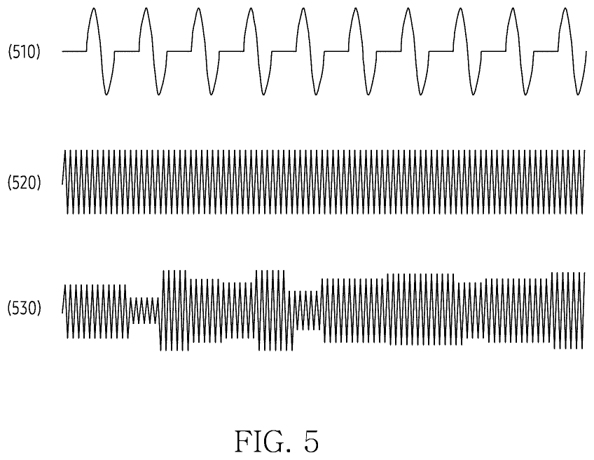

FIG. 5 illustrates an example of haptic information according to an embodiment. An electronic device 101 of FIG. 5 may include the electronic device 101 of FIGS. 1A, 1B, 2A, 2B, 3, and/or 4. Operations of FIG. 5 may be executed by the processor 120 of FIGS. 1A and/or 1B.

Referring to FIG. 5, according to an embodiment, the electronic device 101 may obtain haptic information for controlling a haptic actuator (e.g., the haptic actuator 180 of FIGS. 1A and/or 1B). An example of FIG. 5 may include an example of a frequency transmitted to an external electronic device (e.g., the external electronic device 103 of FIG. 1A) including the haptic actuator or outputted by the haptic actuator included in the electronic device 101. For example, the electronic device 101 may transmit haptic information for adjusting the frequency outputted by the haptic actuator to the external electronic device. For example, the electronic device 101 may adjust current and/or voltage of the frequency. The electronic device 101 may transmit haptic information including the current and/or the voltage of the frequency to the external electronic device based on adjusting the current and/or the voltage of the frequency. A horizontal axis of a graph illustrated in FIG. 5 may mean time. A vertical axis of the graph illustrated in FIG. 5 may mean voltage. However, it is not limited thereto.

According to an embodiment, while outputting a media content, the electronic device 101 may obtain haptic information for outputting haptic feedback synchronized with the media content. FIG. 5 may include an example of a frequency waveform of a first form 510 to a third form 530 of FIG. 5 may be included. However, it is not limited thereto. The frequency waveform of the first form 510 to the third form 530 may include a frequency waveform outputted by the haptic actuator. However, it is not limited thereto.

According to an embodiment, the electronic device 101 may obtain haptic information including a frequency waveform of the first form 510. For example, the electronic device 101 may obtain haptic information including the frequency waveform of the first form 510 based on identifying a first visual object included in the media content. For example, the first visual object may include an object having a smooth texture, such as an ice cube. The electronic device 101 may transmit the haptic information including the frequency waveform of the first form 510 to the external electronic device. For example, the haptic information including the frequency waveform of the first form 510 may include haptic information for representing the smooth texture such as the ice cube. However, it is not limited thereto.

According to an embodiment, the electronic device 101 may obtain haptic information including a frequency waveform of a second form 520. For example, the electronic device 101 may obtain haptic information including the frequency waveform of the second form 520 based on identifying a second visual object included in the media content. For example, the second visual object may include an object having a regular and rough texture, such as a surface of wood. The electronic device 101 may transmit the haptic information including the frequency waveform of the second form 520 to the external electronic device. For example, the haptic information including the frequency waveform of the second form 520 may include haptic information for representing the regular and rough texture such as the surface of the wood. However, it is not limited thereto.

According to an embodiment, the electronic device 101 may obtain haptic information including a frequency waveform of the third form 530. For example, the electronic device 101 may obtain the haptic information including the frequency waveform of the third form 530 based on identifying a third visual object. The third visual object may include an object having an irregular and rough texture such as a rough-sponge. The electronic device 101 may transmit the haptic information including the frequency waveform of the third form 530 to the external electronic device. For example, the haptic information including the frequency waveform of the third form 530 may include haptic information for representing the irregular and rough texture such as the rough-sponge. However, it is not limited thereto.

As described above, according to an embodiment, the electronic device 101 may output a media content. The electronic device 101 may identify a visual object included in the media content in a state of outputting the media content. The electronic device 101 may obtain haptic information for representing a texture corresponding to the visual object based on identifying the visual object. The electronic device 101 may transmit the haptic information to the external electronic device. The electronic device 101 may transmit the haptic information for representing the texture corresponding to the visual object to the external electronic device, and the external electronic device may control the haptic actuator based on the haptic information. The electronic device 101 and/or the external electronic device may enhance a user experience of the electronic device 101 and/or the external electronic device by controlling the haptic actuator based on the haptic information for representing the texture.

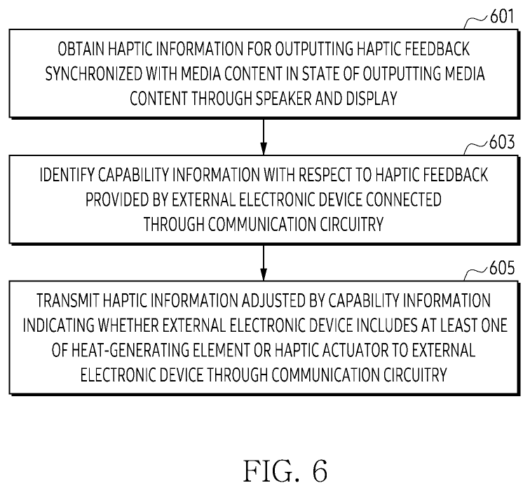

FIG. 6 illustrates an example of a flowchart of an operation of an electronic device according to an embodiment. An electronic device of FIG. 6 may include the electronic device 101 of FIGS. 1A, 1B, 2A, 2B, 3, 4, and/or 5. Operations of FIG. 6 may be executed by the processor 120 of FIGS. 1A and/or 1B. In the following embodiment, each of the operations may be sequentially performed, but is not necessarily performed sequentially. For example, an order of each of the operations may be changed, and at least two operations may be performed in parallel.

Referring to FIG. 6, in an operation 601, according to an embodiment, the electronic device may output a media content through a speaker (e.g., the speaker 150 of FIGS. 1A and/or 1B) and a display (e.g., the display 140 of FIGS. 1A and/or 1B). The electronic device may obtain haptic information for outputting haptic feedback synchronized with the media content in a state of outputting the media content. For example, the haptic information may include information for controlling a heat-generating element (e.g., the heat-generating element 170 of FIG. 1A) and/or a haptic actuator (e.g., the haptic actuator 180 of FIG. 1A) included in an external electronic device (e.g., the external electronic device 103 of FIG. 1A). For example, the haptic information may be related to haptic feedback generated by the heat-generating element and/or the haptic actuator.

In an operation 603, according to an embodiment, the electronic device may identify capability information for haptic feedback supported by the external electronic device connected through communication circuitry (e.g., the communication circuitry 160 of FIG. 1A). For example, the capability information may be related to components included in the external electronic device. For example, the capability information may be related to whether the components are included in the external electronic device. For example, the capability information may be related to a specification of the components included in the external electronic device.

In an operation 605, according to an embodiment, the electronic device may identify capability information indicating whether the external electronic device includes at least one of the heat-generating element or the haptic actuator. The electronic device may adjust haptic information based on identifying the capability information. For example, the electronic device may identify first information for controlling the heat-generating element included in the haptic information based on the capability information. For example, the electronic device may identify second information for controlling the haptic actuator included in the haptic information based on the capability information. For example, the electronic device may change the first information into third information based on identifying capability information related to the haptic actuator among the heat-generating element and the haptic actuator. For example, the electronic device may change the first information into the third information for controlling the haptic actuator based on identifying the capability information. For example, the electronic device may change the second information to fourth information based on identifying capability information related to the heat-generating element among the heat-generating element and the haptic actuator. For example, the electronic device may change the second information into the fourth information for controlling the heat-generating element based on identifying the capability information. The electronic device may transmit haptic information including the changed information to the external electronic device. For example, the electronic device may transmit haptic information adjusted by capability information indicating whether the external electronic device includes at least one of the heat-generating element or the haptic actuator to the external electronic device through communication circuitry.

As described above, according to an embodiment, the electronic device may output a media content. The electronic device may obtain haptic information related to the media content in a state of outputting the media content. The electronic device may obtained haptic information for outputting haptic feedback synchronized with the media content. The electronic device may identify capability information for haptic feedback supported by the external electronic device connected through communication circuitry. The electronic device may identify capability information indicating whether the external electronic device includes at least one of the heat-generating element or the haptic actuator. The electronic device may adjust haptic information based on the capability information indicating whether the external electronic device includes at least one of the heat-generating element or the haptic actuator. The electronic device may transmit the adjusted haptic information to the external electronic device through communication circuitry. The electronic device may enhance a user experience of the electronic device by adjusting haptic information based on identifying the capability information of the external electronic device and transmitting the adjusted haptic information.

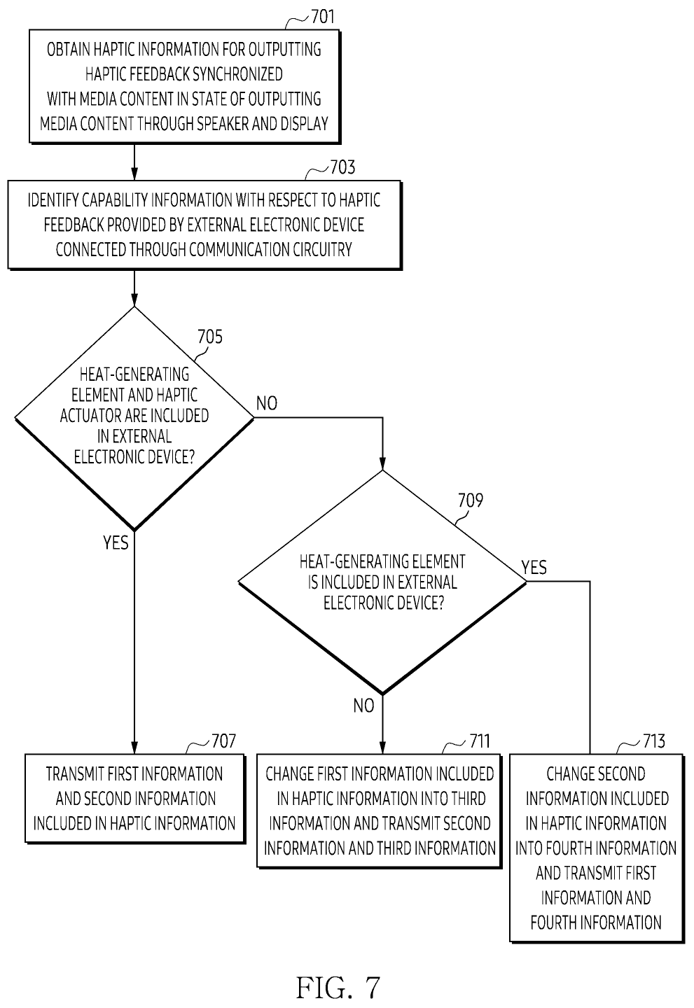

FIG. 7 illustrates an example of a flowchart of an operation of an electronic device according to an embodiment. An electronic device of FIG. 7 may include the electronic device 101 of FIGS. 1A, 1B, 2A, 2B, 3, 4, and/or 5, and/or the electronic device of FIG. 6. Operations of FIG. 7 may be executed by the processor 120 of FIGS. 1A and/or 1B. In the following embodiment, each of the operations may be sequentially performed, but is not necessarily performed sequentially. For example, an order of each of the operations may be changed, and at least two operations may be performed in parallel.

Referring to FIG. 7, in an operation 701, according to an embodiment, an electronic device may output a media content through a speaker (e.g., the speaker 150 of FIGS. 1A and/or 1B) and a display (e.g., the display 140 of FIGS. 1A and/or 1B). The electronic device may obtain haptic information related to the media content in a state of outputting the media content. The electronic device may obtain haptic information for outputting haptic feedback synchronized with the media content in a state of outputting the media content. For example, the electronic device may obtain the haptic information based on a frame of a media content and/or an audio signal.

In an operation 703, according to an embodiment, the electronic device may identify capability information for haptic feedback supported by an external electronic device (e.g., the external electronic device 103 of FIG. 1A) connected through communication circuitry (e.g., the communication circuitry 160 of FIGS. 1A and/or 1B). For example, the capability information may be related to components included in the external electronic device. For example, the capability information may be related to a specification of components included in the external electronic device.

In an operation 705, according to an embodiment, the electronic device may identify whether a heat-generating element and a haptic actuator are included in the external electronic device based on the capability information. The electronic device may identify the heat-generating element included in the external electronic device. The electronic device may identify the haptic actuator included in the external electronic device.

In case (the operation 705—YES) that the external electronic device includes the heat-generating element and the haptic actuator, in an operation 707, according to an embodiment, the electronic device may transmit haptic information. For example, the electronic device may identify first information for controlling the heat-generating element included in the haptic information. The electronic device may identify second information for controlling the haptic actuator included in the haptic information. The electronic device may transmit the first information and the second information to the external electronic device based on identifying that the external electronic device includes the heat-generating element and the haptic actuator.

In case (the operation 705—NO) that the external electronic device does not include the heat-generating element and the haptic actuator, in an operation 709, according to an embodiment, the electronic device may identify whether the external electronic device includes at least one of the heat-generating element or the haptic actuator. For example, the electronic device may identify whether the external electronic device includes the heat-generating element. For example, the electronic device may identify the heat-generating element included in the external electronic device. For example, the electronic device may identify whether the external electronic device includes the haptic actuator. For example, the electronic device may identify the haptic actuator included in the external electronic device.

In case (the operation 709—NO) that the heat-generating element is not included in the external electronic device, in an operation 711, according to an embodiment, the electronic device may identify the haptic actuator included in the external electronic device. The electronic device may change the first information included in haptic information into third information based on identifying the haptic actuator included in the external electronic device. For example, the first information may include information for controlling the heat-generating element. For example, the third information may include information for controlling the haptic actuator. The electronic device may transmit the second information and the third information to the external electronic device based on changing the first information into the third information. For example, the second information may include information for controlling the haptic actuator.

In case (the operation 709—YES) that the heat-generating element is included in the external electronic device, in an operation 713, according to an embodiment, the electronic device may identify the heat-generating element included in the external electronic device. The electronic device may change the second information included in the haptic information into fourth information based on identifying the heat-generating element included in the external electronic device. For example, the second information may include information for controlling the haptic actuator. For example, the fourth information may include information for controlling the heat-generating element. The electronic device may transmit the third information and the fourth information to the external electronic device based on changing the second information into the fourth information.

According to an embodiment, the electronic device may change haptic information based on capability information of the external electronic device. For example, the electronic device may change the haptic information based on the capability information for haptic feedback supported by the external electronic device. According to an embodiment, the electronic device may adjust the haptic information based on a specification of components included in the external electronic device.

As described above, according to an embodiment, the electronic device may identify components included in the external electronic device. The electronic device may change haptic information obtained from a media content based on the components included in the external electronic device. For example, the electronic device may change the haptic information based on the capability information for haptic feedback supported by the external electronic device. The electronic device may enhance a user experience of the electronic device and/or the external electronic device by changing the haptic information and transmitting the haptic information to the external electronic device.

As described above, according to an embodiment, an electronic device 101 may comprise a display 140, a speaker 150, communication circuitry 160, and a processor 120. The processor 120 may, in a state of outputting a media content through the speaker 150 and the display 140, obtain haptic information to output haptic feedback synchronized with the media content. The processor 120 may identify capability information with respect to haptic feedback provided by an external electronic device 103 connected through the communication circuitry 160. The processor may transmit, to the external electronic device 103 through the communication circuitry 160, haptic information adjusted by the capability information indicating whether the external electronic device 103 includes at least one of a heat-generating element 170 or a haptic actuator 180.

As described above, according to an embodiment, an electronic device 101 may, in a state of outputting a media content, obtain haptic information for outputting haptic feedback synchronized with the media content. The electronic device 101 may identify capability information with respect to haptic feedback provided by an external electronic device 103 connected through communication circuitry 160. The electronic device 101 may transmit haptic information adjusted by the capability information indicating whether the external electronic device 103 includes at least one of a heat-generating element 170 or a haptic actuator 180. The electronic device 101 may enhance a user experience of the electronic device 101 and/or the external electronic device 103 by transmitting the adjusted haptic information.

According to an embodiment, the processor 120 may obtain, from a frame of the media content, an average value with respect to colors of pixels in the frame based on at least one of reference colors to form a color space. The processor 120 may obtain the haptic information based on the average value.

According to an embodiment, the processor 120 may obtain the haptic information based on frequency distribution of an audio signal included in the media content.

According to an embodiment, the processor 120 may obtain the haptic information based on scene analysis with respect to frames included in the media content.

According to an embodiment, the processor 120 may obtain the haptic information, based on motion of a visual object identified in frames included in the media content.

According to an embodiment, the processor 120 may identify first information to control the heat-generating element 170 included in the haptic information or second information to control the haptic actuator 180 included in the haptic information.

According to an embodiment, the processor 120 may change, based on identifying the capability information, the first information to third information to control the haptic actuator 180.

According to an embodiment, the processor 120 may change, based on identifying the capability information, the second information to fourth information to control the heat-generating element 170.

As described above, a method of an electronic device 101 according to an embodiment may comprise, in a state of outputting a media content through a speaker 150 and a display 140, obtaining haptic information to output haptic feedback synchronized with the media content. The method of the electronic device 101 may comprise identifying capability information with respect to haptic feedback provided by an external electronic device 103 connected through communication circuitry 160. The method of the electronic device 101 may comprise transmitting, to the external electronic device 103 through the communication circuitry 160, haptic information adjusted by the capability information indicating whether the external electronic device 103 includes at least one of a heat-generating element 170 or a haptic actuator 180.

The method of the electronic device 101 according to an embodiment may comprise obtaining, from a frame of the media content, an average value with respect to colors of pixels in the frame based on at least one of reference colors to form a color space. The method of the electronic device 101 may comprise obtaining the haptic information based on the average value.

The method of the electronic device 101 according to an embodiment may comprise obtaining the haptic information based on frequency distribution of an audio signal included in the media content.

The method of the electronic device 101 according to an embodiment may comprise obtaining the haptic information based on scene analysis with respect to frames included in the media content.

The method of the electronic device 101 according to an embodiment may comprise obtaining the haptic information, based on motion of a visual object identified in frames included in the media content.

The method of the electronic device 101 according to an embodiment may comprise identifying first information to control the heat-generating element 170 included in the haptic information or second information to control the haptic actuator 180 included in the haptic information.

The method of the electronic device 101 according to an embodiment may comprise changing, based on identifying the capability information, the first information to third information to control the haptic actuator 180.

The method of the electronic device 101 according to an embodiment may comprise changing, based on identifying the capability information, the second information to fourth information to control the heat-generating element 170.

As described above, in a computer-readable storage medium storing one or more programs, according to an embodiment, the one or more programs, when executed by a processor 120 of an electronic device 101, may cause the processor 120 of the electronic device 101 to, in a state of outputting a media content through a speaker 150 and a display 140, obtain haptic information to output haptic feedback synchronized with the media content. The one or more programs, when executed by the processor 120 of the electronic device 101, may cause the processor 120 of the electronic device 101 to identify capability information with respect to haptic feedback provided by an external electronic device 103 connected through communication circuitry 160. The one or more programs, when executed by the processor 120 of the electronic device 101, may cause the processor 120 of the electronic device 101 to transmit, to the external electronic device 103 through the communication circuitry 160, haptic information adjusted by the capability information indicating whether the external electronic device 103 includes at least one of a heat-generating element 170 or a haptic actuator 180.

According to an embodiment, the one or more programs, when executed by the processor 120 of the electronic device 101, may cause the processor 120 of the electronic device 101 to obtain, from a frame of the media content, an average value with respect to colors of pixels in the frame based on at least one of reference colors to form a color space. The one or more programs, when executed by the processor 120 of the electronic device 101, may cause the processor 120 of the electronic device 101 to obtain the haptic information based on the average value.

According to an embodiment, the one or more programs, when executed by the processor 120 of the electronic device 101, may cause the processor 120 of the electronic device 101 to obtain the haptic information based on frequency distribution of an audio signal included in the media content.

According to an embodiment, the one or more programs, when executed by the processor 120 of the electronic device 101, may cause the processor 120 of the electronic device 101 to obtain the haptic information based on scene analysis with respect to frames included in the media content.

According to an embodiment, the one or more programs, when executed by the processor 120 of the electronic device 101, may cause the processor 120 of the electronic device 101 to obtain the haptic information, based on motion of a visual object identified in frames included in the media content.

According to an embodiment, the one or more programs, when executed by the processor 120 of the electronic device 101, may cause the processor 120 of the electronic device 101 to identify first information to control the heat-generating element 170 included in the haptic information or second information to control the haptic actuator 180 included in the haptic information.

According to an embodiment, the one or more programs, when executed by the processor 120 of the electronic device 101, may cause the processor 120 of the electronic device 101 to change, based on identifying the capability information, the first information to third information to control the haptic actuator 180.

According to an embodiment, the one or more programs, when executed by the processor 120 of the electronic device 101, may cause the processor 120 of the electronic device 101 to change, based on identifying the capability information, the second information to fourth information to control the heat-generating element 170.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element. Thus, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a display;
a speaker;
communication circuitry;
memory comprising one or more storage media storing instructions; and
at least one processor comprising processing circuitry, wherein the instructions, when executed by the at least one processor individually or collectively, cause the electronic device to:
in a state of outputting a media content through the speaker and the display, obtain haptic information to output haptic feedback synchronized with the media content;
identify capability information with respect to haptic feedback provided by an external electronic device connected through at least the communication circuitry; and
control to transmit, to the external electronic device through at least the communication circuitry, haptic information adjusted by the capability information indicating whether the external electronic device includes at least one of a heat-generating element or a haptic actuator.

2. The electronic device of claim 1, wherein the instructions, when executed by the at least one processor individually or collectively, cause the electronic device to:
obtain, from a frame of the media content, an average value with respect to colors of pixels in the frame based on at least one of reference colors to form a color space; and
obtain the haptic information based on the average value.

3. The electronic device of claim 1, wherein the instructions, when executed by the at least one processor individually or collectively, cause the electronic device to:
obtain the haptic information based on frequency distribution of an audio signal included in the media content.

4. The electronic device of claim 1, wherein the instructions, when executed by the at least one processor individually or collectively, cause the electronic device to:
obtain the haptic information based on scene analysis with respect to frames included in the media content.

5. The electronic device of claim 1, wherein the instructions, when executed by the at least one processor individually or collectively, cause the electronic device to:
obtain the haptic information, based on motion of a visual object identified in frames included in the media content.

6. The electronic device of claim 1, wherein the instructions, when executed by the at least one processor individually or collectively, cause the electronic device to:
identify first information to control the heat-generating element included in the haptic information and/or second information to control the haptic actuator included in the haptic information.

7. The electronic device of claim 6, wherein the instructions, when executed by the at least one processor individually or collectively, cause the electronic device to:
change, based on identifying the capability information, the first information to third information to control the haptic actuator.

8. The electronic device of claim 6, wherein instructions, when executed by the at least one processor individually or collectively, cause the electronic device to:
change, based on identifying the capability information, the second information to fourth information to control the heat-generating element.

9. A method of an electronic device, comprising:
in a state of outputting a media content through at least a speaker and a display, obtaining haptic information to output haptic feedback synchronized with the media content;
identifying capability information with respect to haptic feedback provided by an external electronic device; and
transmitting, to the external electronic device, haptic information adjusted by at least the capability information indicating whether the external electronic device includes at least one of a heat-generating element or a haptic actuator.

10. The method of claim 9, comprising:
obtaining, from frame of the media content, an average value with respect to colors of pixels in the frame based on at least one of reference colors to form a color space; and
obtaining the haptic information based on the average value.

11. The method of claim 9, comprising:
obtaining the haptic information based on frequency distribution of an audio signal included in the media content.

12. The method of claim 9, comprising:
obtaining the haptic information based on scene analysis with respect to frames included in the media content.

13. The method of claim 9, comprising:
obtaining the haptic information, based on motion of a visual object identified in frames included in the media content.

14. The method of claim 9, comprising:
identifying first information to control the heat-generating element included in the haptic information and/or second information to control the haptic actuator included in the haptic information.

15. The method of claim 14, comprising:
changing, based on identifying the capability information, the first information to third information to control the haptic actuator.

16. A non-transitory computer readable storage medium storing instructions, wherein the instructions, when executed by an electronic device including a display, a processor, a speaker, and communication circuitry, cause the electronic device to:
in a state of outputting a media content through the speaker and the display, obtain haptic information to output haptic feedback synchronized with the media content;
identify capability information with respect to haptic feedback provided by an external electronic device connected through the communication circuitry; and
transmit, to the external electronic device, haptic information adjusted by the capability information indicating whether the external electronic device includes at least one of a heat-generating element or a haptic actuator.

17. The non-transitory computer readable storage medium of claim 16, wherein the instructions, when executed by the electronic device, cause the electronic device to:
obtain, from a frame of the media content, an average value with respect to colors of pixels in the frame based on at least one of reference colors to form a color space; and
obtain the haptic information based on the average value.

18. The non-transitory computer readable storage medium of claim 16, wherein the instructions, when executed by the electronic device, cause the electronic device to:
obtain the haptic information based on frequency distribution of an audio signal included in the media content.

19. The non-transitory computer readable storage medium of claim 16, wherein the instructions, when executed by the electronic device, cause the electronic device to:
obtain the haptic information based on scene analysis with respect to frames included in the media content.

20. The non-transitory computer readable storage medium of claim 16, wherein the instructions, when executed by the electronic device, cause the electronic device to:
obtain the haptic information, based on motion of a visual object identified in frames included in the media content.
